(19) United States
(12) Patent Application Publication
(10) Pub. No.: US 2025/0008285 A1
(43) Pub. Date: Jan. 2, 2025

(54) An Apparatus, Method and Computer Program for Determining Microphone Blockages

(71) Applicant: Nokia Technologies Oy, Espoo (FI)

(72) Inventors: Juha Tapio VILKAMO, Helsinki (FI); Miikka Tapani VILERMO, Siuro (FI); Mikko Tapio TAMMI, Tampere (FI)

(21) Appl. No.: 18/576,795

(22) PCT Filed: Jun. 20, 2022
(86) PCT No.: PCT/FI2022/050433

§ 371 Date: Jan. 5, 2024

(30) Foreign Application Priority Data
Jul. 9, 2021 (GB) 2109928.8

(51) Int. Cl. H04R 29/00; H04R 1/40; H04R 3/00

(52) U.S. Cl. CPC H04R 29/005; H04R 1/406; H04R 3/005

(57) ABSTRACT

Examples of the disclosure relate to an apparatus (201) for determining whether one or more microphones (207) within a plurality of microphones is blocked. In examples of the disclosure correlation between at least two microphones is estimated so as to provide an indication of whether or not incoherent noise, such as wind noise (205), is present. This can be used to avoid incorrectly identifying a microphone as being blocked and so can help to maintain a higher quality level for the audio signals captured by the microphones.

### TECHNOLOGICAL FIELD

Examples of the disclosure relate to apparatus, methods and computer programs for determining microphone blockages. Some relate to apparatus, methods and computer programs for determining microphone blockages in handheld electronic devices.

### BACKGROUND

Blockages of microphones can reduce the quality of audio captured by devices. This can be problematic for handheld electronic devices where the microphones could be blocked by a user's fingers or any other dirt or objects. It is useful to be able to determine whether or not a microphone is blocked.

### BRIEF SUMMARY

According to various, but not necessarily all, examples of the disclosure there is provided an apparatus comprising means for:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of frequency bands is selected based at least in part on the distance between the at least two microphones and wherein the first frequency band comprises higher frequencies than the second frequency band.

The incoherent noise may comprise at least one of: wind noise, handling noise.

The processing of the microphone signals in the second frequency band may also comprise detecting if at least one of the microphone signals levels is close to a microphone self-noise level and adjusting an estimation of how predominant incoherent noise is within the microphone signals based on how close the microphone signal level is to the microphone self-noise level.

Using outputs of the processing in the first frequency band and the processing in the second frequency band to determine whether or not a microphone within the at least two microphones is blocked may comprise determining that a signal level difference is present in the microphone signals and determining that the signal level difference is not attributable to incoherent noise.

The first frequency band might not overlap with the second frequency band.

The first frequency band may be selected based on the distance between the at least two microphones and acoustic shadowing of the at least two microphones such that energy level differences corresponding to a detected sound signal are low regardless of the direction that the sound signal arrives from.

The second frequency band may be selected based on the distance between the at least two microphones and acoustic shadowing of the at least two microphones such that a phase difference between microphone signals from a sound source is low.

The frequency bands may be selected based at least in part, on acoustic shadowing of the at least two microphones.

An upper frequency limit of the frequency bands may be determined by an amount of acoustic shadowing.

According to various, but not necessarily all, examples of the disclosure there is provided an apparatus comprising at least one processor; and at least one memory including computer program code, the at least one memory and the computer program code configured to, with the at least one processor, cause the apparatus at least to perform:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of frequency bands is selected based at least in part on the distance between the at least two microphones and wherein the first frequency band comprises higher frequencies than the second frequency band.

According to various, but not necessarily all, examples of the disclosure there is provided a handheld electronic device comprising an apparatus as claimed in any preceding claim.

According to various, but not necessarily all, examples of the disclosure there is provided a method comprising:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of the frequency bands is selected based at least in part on the distance between the at least two microphones and wherein the first frequency band comprises higher frequencies than the second frequency band.

According to various, but not necessarily all, examples of the disclosure there is provided a computer program comprising computer program instructions that, when executed by processing circuitry, cause:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of the frequency bands is selected based at least in part on the distance between the at least two microphones and wherein the first frequency band comprises higher frequencies than the second frequency band.

According to various, but not necessarily all, examples of the disclosure there is provided an apparatus comprising means for:
obtaining microphone signals from at least two microphones;
processing the microphone signals in at least one frequency band to determine correlation between the at least two microphones;
detecting if at least one of the microphone signal levels is close to a microphone self-noise level;
estimating incoherent noise within the microphone signals based on the correlation between the at least two microphones and whether or not at least one of the microphone signal levels is close to the microphone self-noise level; and
providing spatial audio output based on the microphone signals and an estimation of how predominant incoherent noise is within the microphone signals.

The frequency band may be selected based at least in part on the distance between the at least two microphones.

The frequency band may be selected based on the distance between the at least two microphones and acoustic shadowing of the at least two microphones such that a phase difference between microphone signals from a sound source is low.

According to various, but not necessarily all, examples of the disclosure there is provided an apparatus comprising at least one processor; and at least one memory including computer program code, the at least one memory and the computer program code configured to, with the at least one processor, cause the apparatus at least to perform:
obtaining microphone signals from at least two microphones;
processing the microphone signals in at least one frequency band to determine correlation between the at least two microphones;
detecting if at least one of the microphone signal levels is close to a microphone self-noise level;
estimating incoherent noise within the microphone signals based on the correlation between the at least two microphones and whether or not at least one of the microphone signal levels is close to the microphone self-noise level; and
providing spatial audio output based on the microphone signals and an estimation of how predominant incoherent noise is within the microphone signals.

According to various, but not necessarily all, examples of the disclosure there is provided a method comprising:
obtaining microphone signals from at least two microphones;
processing the microphone signals in at least one frequency band to determine correlation between the at least two microphones;
detecting if at least one of the microphone signal levels is close to a microphone self-noise level;
estimating incoherent noise within the microphone signals based on the correlation between the at least two microphones and whether or not at least one of the microphone signal levels is close to the microphone self-noise level; and
providing spatial audio output based on the microphone signals and an estimation of how predominant incoherent noise is within the microphone signals.

According to various, but not necessarily all, examples of the disclosure there is provided a computer program comprising computer program instructions that, when executed by processing circuitry, cause:
obtaining microphone signals from at least two microphones;
processing the microphone signals in at least one frequency band to determine correlation between the at least two microphones;
detecting if at least one of the microphone signal levels is close to a microphone self-noise level;
estimating incoherent noise within the microphone signals based on the correlation between the at least two microphones and whether or not at least one of the microphone signal levels is close to the microphone self-noise level; and
providing spatial audio output based on the microphone signals and an estimation of how predominant incoherent noise is within the microphone signals.

### BRIEF DESCRIPTION

Some examples will now be described with reference to the accompanying drawings in which:

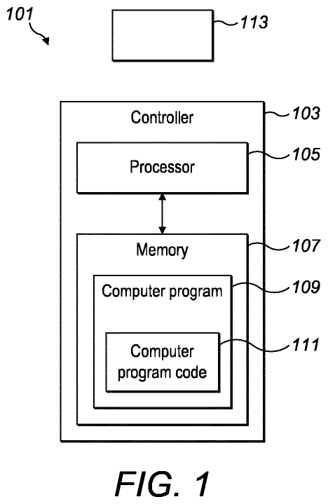

FIG. 1 shows an example apparatus;

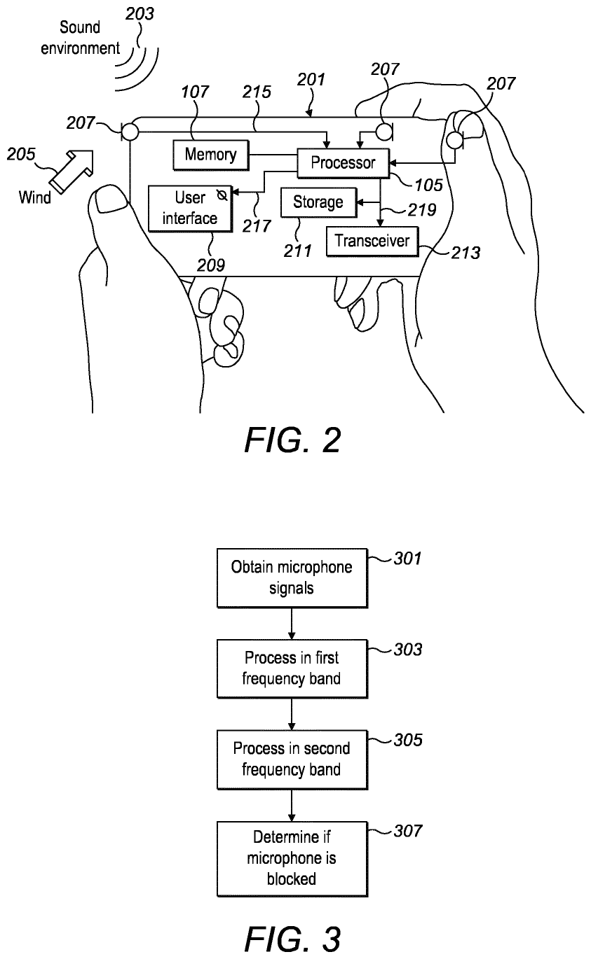

FIG. 2 shows an example handheld electronic device;

FIG. 3 shows an example method;

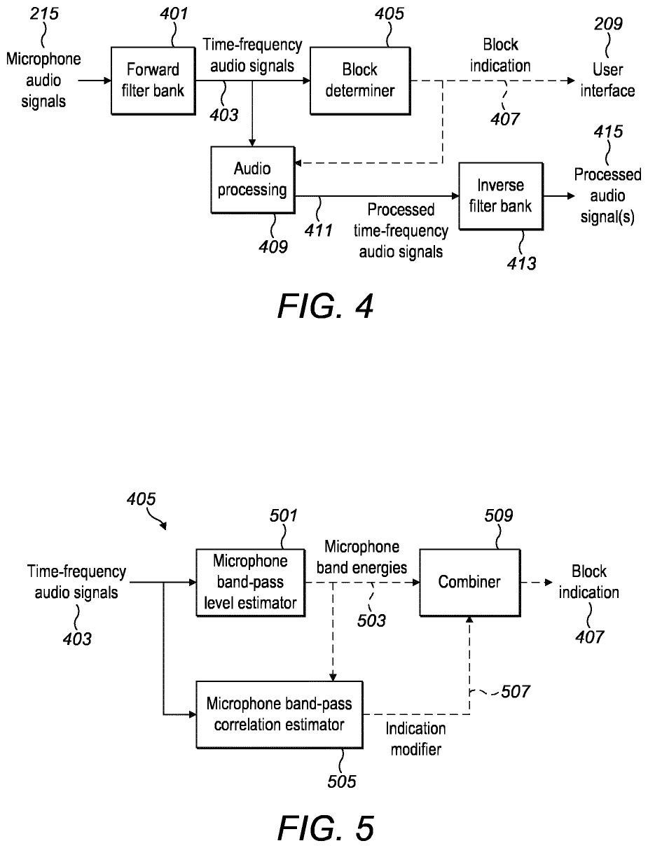

FIG. 4 shows an example method;

FIG. 5 shows an example method;

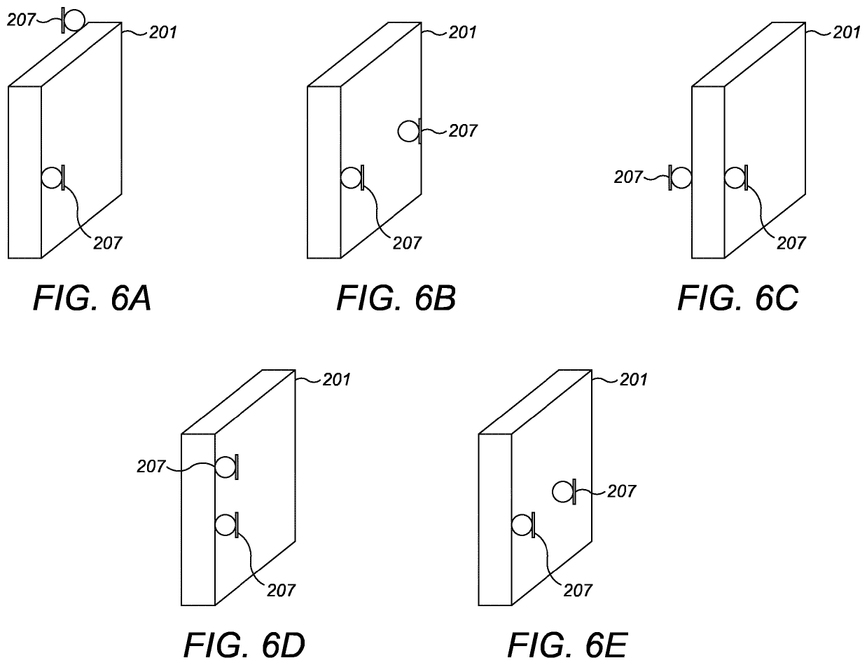

FIGS. 6A to 6E show example handheld electronic devices;

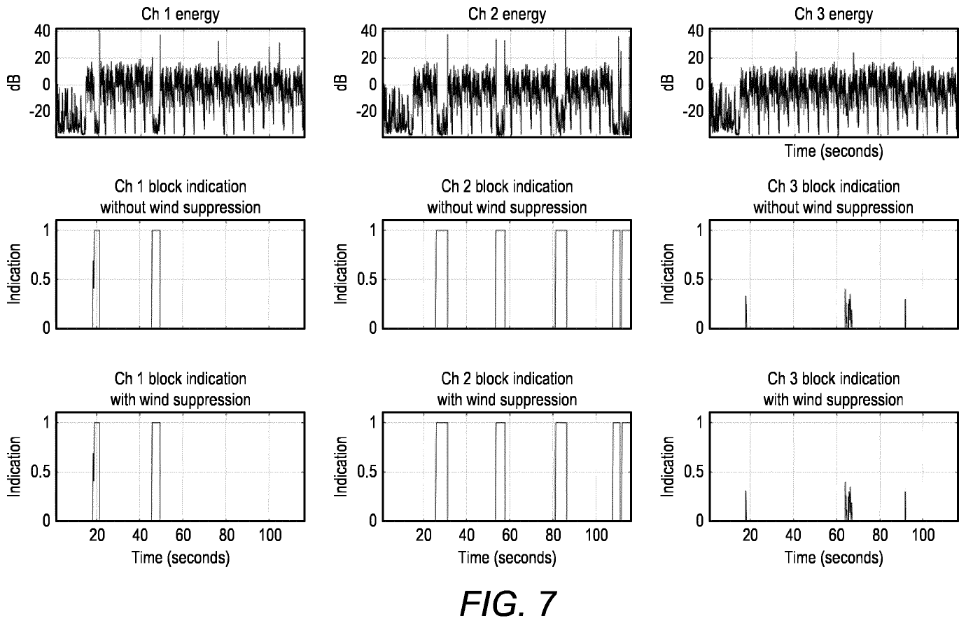

FIG. 7 shows example block indication values;

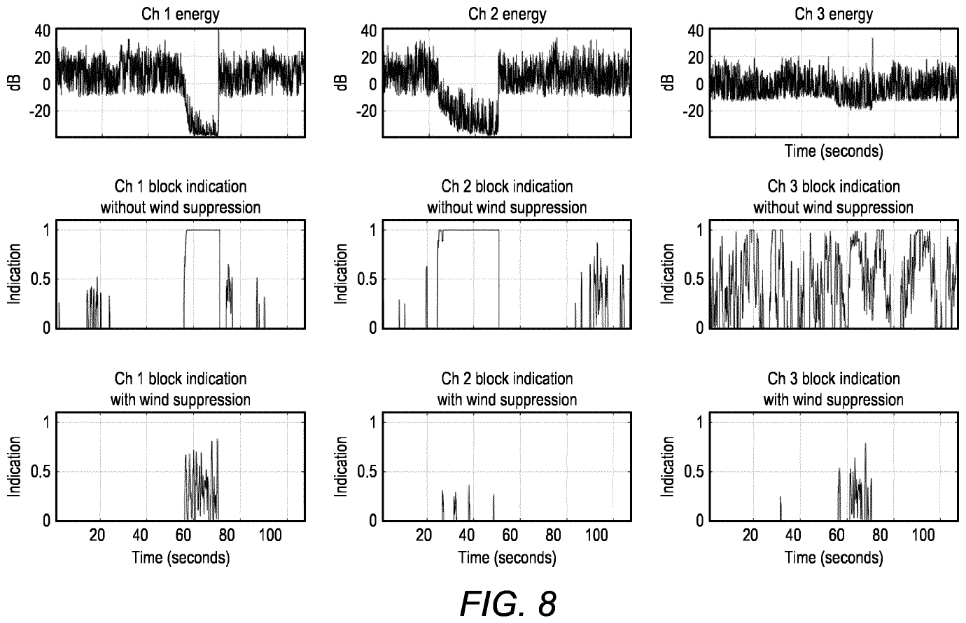

FIG. 8 shows example block indication values; and

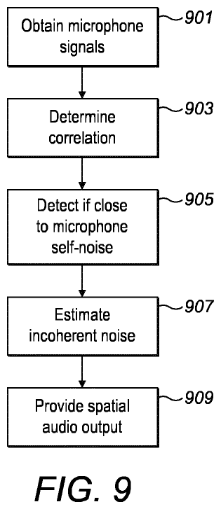

FIG. 9 shows an example method.

### DETAILED DESCRIPTION

Examples of the disclosure relate to an apparatus for determining whether one or more microphones within a plurality of microphones is blocked. In examples of the disclosure correlation between at least two microphones is estimated so as to provide an indication of whether or not incoherent noise, such as wind noise, is present. This can be used to avoid incorrectly identifying a microphone as being blocked and so can help to maintain a higher quality level for the audio signals captured by the microphones.

FIG. 1 schematically shows an example apparatus 101 that can be used to implement examples of the disclosure. The apparatus 101 illustrated in FIG. 1 can be a chip or a chip-set. In some examples the apparatus 101 can be provided within handheld electronic devices 201 such as mobile phones, tablet computers, cameras or other suitable devices.

In the example of FIG. 1 the apparatus 101 comprises a controller 103. In the example of FIG. 1 the implementation of the controller 103 can be as controller circuitry. In some examples the controller 103 can be implemented in hardware alone, have certain aspects in software including firmware alone or can be a combination of hardware and software (including firmware).

As illustrated in FIG. 1 the controller 103 can be implemented using instructions that enable hardware functionality, for example, by using executable instructions of a computer program 109 in a general-purpose or special-purpose processor 105 that can be stored on a computer readable storage medium (disk, memory etc.) to be executed by such a processor 105.

The processor 105 is configured to read from and write to the memory 107. The processor 105 can also comprise an output interface via which data and/or commands are output by the processor 105 and an input interface via which data and/or commands are input to the processor 105.

The memory 107 is configured to store a computer program 109 comprising computer program instructions (computer program code 111) that controls the operation of the apparatus 101 when loaded into the processor 105. The computer program instructions, of the computer program 109, provide the logic and routines that enables the apparatus 101 to perform the methods illustrated in FIGS. 3 to 5. The processor 105 by reading the memory 107 is able to load and execute the computer program 109.

The apparatus 101 therefore comprises means for:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of frequency bands is selected based at least in part on the distance between the at least two microphones and wherein the first frequency band comprises higher frequencies than the second frequency band.

As illustrated in FIG. 1 the computer program 109 can arrive at the apparatus 101 via any suitable delivery mechanism 113. The delivery mechanism 113 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 109. The delivery mechanism can be a signal configured to reliably transfer the computer program 109. The apparatus 101 can propagate or transmit the computer program 109 as a computer data signal. In some examples the computer program 109 can be transmitted to the apparatus 101 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 109 comprises computer program instructions for causing an apparatus 101 to perform at least the following:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of frequency bands is selected based at least in part on the distance between the at least two microphones and wherein the first frequency band comprises higher frequencies than the second frequency band.

The computer program instructions can be comprised in a computer program 109, a non-transitory computer readable medium, a computer program product, a machine readable medium. In some but not necessarily all examples, the computer program instructions can be distributed over more than one computer program 109.

Although the memory 107 is illustrated as a single component/circuitry it can be implemented as one or more separate components/circuitry some or all of which can be integrated/removable and/or can provide permanent/semi-permanent/dynamic/cached storage.

Although the processor 105 is illustrated as a single component/circuitry it can be implemented as one or more separate components/circuitry some or all of which can be integrated/removable. The processor 105 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions and
(c) hardware circuit(s) and or processor(s), such as a microprocessor(s) or a portion of a microprocessor(s), that requires software (such as firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIGS. 3 to 5 can represent steps in a method and/or sections of code in the computer program 109. The illustration of a particular order to the blocks does not necessarily imply that there is a required or preferred order for the blocks and the order and arrangement of the block can be varied. Furthermore, it can be possible for some blocks to be omitted.

FIG. 2 shows an example handheld electronic device 201 that could be used in some examples of the disclosure.

The handheld electronic device 201 comprises a memory 107, processor 105, user interface 209, storage 211, transceiver 213 and a plurality of microphones 207. Only components that are referred to in the following description are shown in FIG. 2. It is to be appreciated that the handheld electronic device 201 could comprise additional components in some examples of the disclosure. For instance, the handheld electronic device 201 could comprise a power sources, a camera or any other suitable additional components.

The memory 107 and the processor 105 can be part of a controller apparatus 101 as shown in FIG. 1. The memory 107 can be configured to store a computer program 109 that can be executed to implement methods according to examples of the disclosure.

The handheld electronic device 201 comprises at least two microphones 207. In the example of FIG. 2 the handheld electronic device 201 comprises three microphones. Other numbers of microphones 207 could be used in other examples of the disclosure.

The microphones 207 can comprise any means that can be configured to capture sound from the sound environment 203 and enable a microphone signal 215 to be provided. The microphone signals 215 comprise an electrical signal that represents at least some of the sound environment 203 captured by the microphones 207.

The microphones 207 can be provided at different positions within the handheld electronic device 201 to enable spatial audio signals to be captured. In the example of FIG. 2 a first microphone 207 is provided at a first end of the handheld electronic device 201 and two other microphones 207 are provided at a second, opposite end of the handheld electronic device 201. Other configurations that could be used for the microphones are shown in FIGS. 6A to 6E.

The microphones 207 can be configured to provide the microphone signals 215 in any suitable format. In some examples the microphones 207 can be configured to provide the microphone signals 215 in a pulse code modulation (PCM) format. In other examples the microphones 207 could be analogue microphones 207. In such examples an analogue-to-digital converter can be provided between the microphones 207 and the processor 105.

The microphones 201 are coupled to the processor 105 so that the microphone signals 215 are provided to the processor 105 for processing. The processor 105 is also coupled to the memory 107 to enable the processor 105 to access the computer programs 109 stored within the memory 107.

The processing of the microphone signals can comprise any processing that provides audio signals 219 as an output. For example, the processor 105 could be configured to perform audio processing algorithms, such as equalization, automatic gain control, microphone noise suppression, audio focusing, spatial noise suppression, wind noise reduction or any other suitable audio processing.

The audio signals 219 can be provided by the processor 105 in any suitable format. For example, the audio signals can be provided in advanced Audio Coding (AAC) encoded form (such as, in mono, stereo, binaural, multi-channel, or Ambisonics). In some examples other formats could be used, such as PCM audio (mono, stereo, or other suitable format).

In some examples an encoding format could be used to encode one or more audio signals together with associated spatial metadata. The spatial metadata can comprise information indicative of the spatial properties of the sound environment 203 that has been captured by the microphones 207. In some examples the spatial metadata can indicate directions of sound in frequency bands, and direct-to-total energy ratios in frequency bands. Such an audio format can be referred to as parametric audio. A parametric audio signal can be rendered to various output formats including stereo, binaural, surround and Ambisonics.

In some examples the audio signals 219 can be associated with another signal such as a video signal or other images.

The processing performed by the processor 105 can also comprise estimating the presence of wind noise 205 or other incoherent noise. The indication of whether or not wind noise is present can be used to help to determine whether or not one or more of the microphones 207 is blocked. This can enable an indication signal 217 to be provided as an output. The indication signal can comprise information indicative of whether or not the one or more of the microphones 207 is blocked. The processing could comprise methods as shown in any of FIGS. 3 to 5.

The handheld electronic device 201 also comprises a user interface 209. The user interface can comprise a display or graphical user interface or any other means for presenting information to a user of the handheld electronic device 201. The handheld electronic device 201 is configured to receive an indication signal 217 from the processor 103. The indication signal can comprise information indicative of whether or not one or more of the microphones 207 is blocked.

The user interface 209 is configured to provide information to the user in response to the indication signal 217. For instance, the user interface 209 could be configured to provide a notification or display a graphical user interface icon indicative of whether or not one or more microphones has been indicated as being blocked in the indication signal 217. In some examples the indication signal 217 and the user interface 209 could be configured to indicate which of the microphones 207 is blocked.

The handheld electronic device 201 as shown in FIG. 2 also comprises a transceiver 213 and storage 211. The processor 105 is coupled to the transceiver 213 and/or the storage 211 so that the processed audio signals 219 can be provided to a transceiver 213 and/or to storage 211.

The transceiver 213 can comprise any means that can enable the processed audio signals to be transmitted from the handheld electronic device 201. This can enable the processed audio signals 219 to be transmitted from the handheld electronic device 201 to an audio rendering device or any other suitable device.

The storage 211 can comprise any means for storing the processed audio signals 219. The storage 211 could comprise one or more memories or any other suitable means.

FIG. 3 shows an example method that could be implemented using an apparatus 101 and handheld electronic device 201 as shown above.

The method comprises, at block 301, obtaining microphone signals 215 from at least two microphones 207. The microphones 207 can be provided within a handheld electronic device 201 as shown in FIG. 2 or within any other suitable type of device.

The microphone signals 215 can be obtained in any suitable format such as PCM.

At block 303 the method comprises processing the microphone signals 215 in a first frequency band to estimate signal levels of the at least two microphones in the first frequency band. The signal levels can be used to estimate a level difference between the at least two microphones in the first frequency band. The signal levels and/or any energy level difference can provide an estimate of whether or not a microphone 207 could be blocked.

In some examples signal levels can be obtained. This can enable a level difference to be determined and can also be used to determine how close the signal levels are to the microphone self-noise.

At block 305 the method comprises processing the microphone signals 215 in a second frequency band to determine correlation between the at least two microphones 207. This provides an estimation of how predominant incoherent noise is within the microphone signals 215. For example, it can provide an indication of whether or not the second frequency band predominantly comprises sounds from sound environment 203 or if the second frequency band predominantly comprises incoherent noise between the microphones. The incoherent noise could comprise wind noise or handling noise or any other suitable type of incoherent noise. The second frequency band is different to the first frequency band.

In some examples the processing 305 of the microphone signals 215 in the second frequency band can also comprises detecting if at least one of the levels of the microphone signals 215 is close to a microphone self-noise level. The indication of whether or not incoherent noise is present can be adjusted based on how close the level of the microphone signal 215 is to the microphone self-noise level. The microphone self-noise comprises noise that is produced by a microphone 207 even when there is no sound source.

If the level of a microphone signal 215 is close to the microphone self-noise level then this could be an indication that the microphone is blocked and none, or very little of the sound environment 203 or the wind noise 205 has been captured by the microphone 207. Therefore, if one of the microphones is close to the microphone self-noise level it could be assumed that this is due to a blockage and a lack of correlation would not be assumed to be an indication that incoherent noise is present.

One or more of the frequency bands that are used for the processing are selected based at least in part on the distance between the at least two microphones 207. The frequency bands can be selected so that the first frequency band comprises higher frequencies than the second frequency band. The frequency bands can be selected so that the first frequency band is higher than the second frequency band. The frequency bands can be selected so that the first frequency band does not overlap with the second frequency band.

Selecting frequency bands based at least in part on the distance between the at least two microphones 207 could comprise using actual distance information between microphones 207 as parameter values, or device measurements (e.g., acoustic, physical, simulations) or any other suitable data to select the frequency bands. For example, the distances between the microphones 207 and/or other information that is related to the distances between the microphones 207 or positions of the microphones 207 can be obtained from recordings captured using an electronic device 201 with at least two microphones 207. For instance, an electronic device 201 could be used to capture sounds at different directions The resulting signal could be monitored to determine how the positions of the microphones 207 and geometry of the electronic device 201 affects the acoustic shadowing and phase differences.

The information relating to how the positions of the microphones 207 and geometry of the electronic device 201 affects the acoustic shadowing and phase differences can be used as information for determining one or both of the frequency bands.

In some examples the frequency bands that are selected based at least in part on the distance between the at least two microphones 207 can determined for one example electronic device 201, and then the same frequency bands could be applied for other electronic devices 201 of approximately the same size. For example, such limits can be determined for one typical mobile phone so that the frequency ranges are appropriate for any typical mobile phone with any typical microphone positioning.

The frequency band limits given in the following examples are an example for such frequency ranges. They are appropriate for a microphone 207 pair for a typical smart phone in a landscape mode having the microphones 207 at edges. The frequency ranges can also be used (even if not particularly optimized) for smaller microphone distances.

The frequency bands can be selected based, at least in part, on acoustic shadowing of the two microphones 207. The acoustic shadowing can be caused by the body of the handheld electronic device 201 attenuating sounds that come from the other side of the handheld electronic device 201 to which the microphone 207 is positioned. The phenomenon of acoustic shadowing is stronger for higher frequencies so an upper frequency limit of the frequency bands can be determined by an amount of acoustic shadowing.

The first frequency band can be selected based on the distance between the microphones 207 and acoustic shadowing of the microphones 207 such that energy level differences corresponding to a detected sound signal are low regardless of the direction that the sound signal arrives from.

The first frequency band can be selected to omit low frequency components such as infrasounds as these can be noisy.

The second frequency band can be selected based on the distance between the microphones 207 and acoustic shadowing of the microphones 207 such that a phase difference between microphone signals 217 from a sound source is low. The phase difference is affected by the distance of the microphone 207 from the sound source. The phenomenon of phase difference is also stronger for higher frequencies.

Where the handheld electronic device 201 comprises more than two microphones 207 different frequency bands can be selected for different pairs of microphones 207 based on the different relative positions of the microphones 207 and the different amounts of acoustic shadowing.

In some examples the first frequency band could be 700 Hz to 7 kHz. However, if the microphones 207 are positioned so that there is a small amount of acoustic shadowing then the upper limit of the frequency band can be increased. Conversely, if the microphones 207 are positioned so that there is a large amount of acoustic shadowing then the upper limit of the frequency band can be decreased.

In some examples the second frequency band could be 50 Hz to 500 Hz. If the microphones 207 are positioned so that there is a small amount of acoustic shadowing and little phase difference caused by the separation of the microphones 207 then the upper limit of the frequency band can be increased. Conversely, if the microphones 207 are positioned so that there is a large amount of acoustic shadowing and a large phase difference caused by the separation of the microphones 207 then the upper limit of the frequency band can be decreased.

At block 307 the method comprises using outputs of the processing in the first frequency band and the processing in the second frequency band to determine whether or not a microphone 207 within the at least two microphones 207 is blocked. Using the outputs of the processing in the first frequency band and the processing in the second frequency band to determine whether or not a microphone 207 is blocked can comprise determining that a signal level difference is present in the microphone signals 217 and determining that the signal level difference is not attributable to incoherent noise. For example, if a level difference is present the correlation between the microphone signals could also be checked. If the correlation is low then this can be an indication that the level difference is caused by wind noise, or other incoherent noise as opposed to the microphone 207 being blocked. By determining whether or not incoherent noise is present this can prevent a microphone 207 being incorrectly identified as blocked.

Therefore, even if a level difference between microphone signals 215 is detected, if incoherent noise can be considered to be causing the difference in noise level, then the microphone with the lower noise level would not be classed as blocked. If the difference in noise level is not considered to be caused by incoherent noise then the microphone 207 with the lower signal level can be considered to be blocked.

In some examples the method can also comprises detecting if there is a sound source that is positioned much closer to one of the microphones 207 than the other. For example, if a first microphone 207 is positioned close to a camera and a second microphone 207 is positioned at an opposite side of the handheld electronic device 201 then, noises generated by the motor of the camera will be much louder for the first microphone 207 than for the second microphone 207. This could also result in significant signal level differences without either of the microphones 207 being blocked. In such examples an input signal could be provided to the processor 105 to indicate if a motor, or other similar component, is running and generating noise that could create these level differences. This input signal could then be used when determining whether or not a microphone 107 is blocked.

The processor 105 can be configured to provide an indication signal 217 that indicates whether or not a microphone 201 is blocked. If a microphone 207 is blocked then an output could be provided to a user to indicate that the microphone 207 is blocked. For instance, the user interface 209 could be configured to display a notification on a display or to provide any suitable other notification to the user. In response to the notification the user could unblock the microphone 207, for instance they could reposition their hands relative to the handheld electronic device 201 so that their hands are not covering the microphones 207.

In other examples if one or more microphones 207 are determined to be blocked the audio processing can be adjusted to take this into account. The adjustments that can be made to the audio processing can be dependent upon the type of audio processing that is being performed, the number of microphones 207 that are available within the handheld electronic device 201, the number of microphones 207 that are blocked and any other suitable factor.

FIG. 4 shows an example method corresponding to the operation of a computer program 109 by processor 105 of the apparatus 101 and the handheld electronic device 201.

The method comprises providing microphone signals 215 to a forward filter bank 401. The forward filter bank 401 can comprise any means that can be configured to convert the microphone signals 215 into a time-frequency domain. Any suitable process can be used to convert the microphone signals 215 into a time-frequency domain such as short-time Fourier transform (STFT) or complex-modulated quadrature mirror filter (QMF) bank

The STFT comprises a procedure that can be configured so that the current and the previous audio frames are divided into windows and processed using a fast Fourier transform (FFT). The result of this is time-frequency domain audio signals 403 which are denoted as S(b, n, i), where b is the frequency bin and n is the temporal frame index, and i is the microphone channel index. The time-frequency domain audio signals 403 are provided as the output of the forward filter bank 401.

The time-frequency domain audio signals 403 are provided as an input to the blocking determiner module 405 and also to the audio processing module 409.

The blocking determiner module 405 is configured to receive the time-frequency domain audio signals 403 and use the time-frequency domain audio signals 403 to generate block indication values 407. The block indication values 407 can provide an indication of which microphones 207 within the handheld electronic device 201 are blocked and which microphones 207 within the handheld electronic device 201 are not blocked.

An example of the process that can be performed by the blocking determiner module 405 is shown in more detail in FIG. 5.

In some examples the block indication values 407 can be provide to a user interface 209 and used to provide an output to a user of the handheld electronic device 201. For instance, if the block indication value 409 indicates that one or more of the microphones 207 are blocked then information indicative of the blocked microphone 207 can be displayed on a display or provided to the user via any other suitable means. When a user is notified that one or more of the microphones 207 is blocked then the user can be prompted to take some action to address the blockage. For instance, the user could be prompted to reposition their hands relative to the microphones 207 so that their hands are not covering the microphones 207.

The block indication values 407 are also provided to the audio processing module 409. The audio processing module 409 can be configured to perform any suitable processing on the time-frequency domain audio signals 403. For example, the audio processing module 409 can be configured to apply equalization, automatic gain control, microphone noise suppression, audio focusing, spatial noise suppression, wind noise reduction, and/or any other suitable processing.

In some examples the audio processing module 409 can use the block indication values 407 to alter the audio processing as appropriate. Whether or not the block indication values 407 are used to alter the audio processing can depend upon the type of audio processing performed by the audio processing module 409.

In some examples the audio processing module 409 can be configured to omit any microphone channels corresponding to microphones that are indicated as being blocked in the block indication values 407 when the output audio is being generated. For example, if the handheld electronic device 201 comprises two microphones 207, and if the block indication values 407 indicate that one of them is blocked, the audio processing module 409 could omit the signal from the blocked microphone 207 and create a dual mono output based on the microphone signal from the microphone 207 that is not blocked. If the handheld electronic device 201 comprises a plurality of microphones 207 at each end then the audio processing module 409 can be configured to select a pair of microphones 207 that are not blocked and generate an output based on the microphone signals 215 from the selected pair of microphones 207.

In another example the audio processing module 409 can be configured to perform ambient noise suppression. The ambient noise suppression can comprise monitoring external sounds to determine the amount of constant ambient noise that is present within the sound environment 203. The constant ambient noise could be caused by fans or air conditioning systems or other suitable sources. The audio processing module 409 uses information indicating the amount of constant ambient noise that is present within the sound environment 203 to suppress a corresponding amount of energy in the time-frequency domain audio signals 403. If the block indication values 407 indicate that one or more of the microphones 207 is blocked then the microphone signals from the blocked microphones 207 can be omitted when the amount of ambient noise is being determined.

In another example the audio processing module 409 can be configured to estimate spatial metadata based on the microphone channels. The spatial metadata can comprise data indicative of spatial properties of the sound environment 203 captured by the plurality of microphones 207. The spatial metadata can be used for rendering a spatial audio output that enables a user to perceive the spatial properties of the sound environment 203. If the block indication values 407 indicate that one or more of the microphones 207 is blocked then the determining of the spatial metadata can be adjusted to take into account the blocked microphone 207. For example, a microphone pair comprising a microphone 207 on a left-hand side of the handheld electronic device 201 and another microphone 207 on the right-hand side of the electronic device 201 can be used to determine an angle of the arriving sound. If the block indication values 409 indicate that one or more of the microphones is blocked then in some handheld electronic devices 201 a different microphone 207 could be selected to replace the blocked microphone 201. If there is not a suitable microphone 207 to use as a replacement then the audio processing module 409 can be configured to override the spatial metadata. The spatial metadata can be overridden by setting the estimated sound direction to remain directly at the centre. This would avoid erroneous fluctuating spatial metadata values, which could cause worse issues for audio quality when compared to rendering the audio only at front.

In other examples the audio processing module 409 might not need to take any additional action if the block indication values 407 indicate that one or more microphones 207 are blocked. For instance, if a notification that one or more microphones 207 are blocked is provided to a user then this could be sufficient to enable the issue to be addressed. For instance, this could enable a user to remove the blocking.

Once the audio processing has been performed the audio processing module provides processed time-frequency audio signals 411 as an output. The processed time-frequency audio signals 411 can be provided to an inverse filter bank 413.

The inverse filter bank 413 can comprise any means that can be configured to receive the processed time-frequency audio signals 411 and apply an inverse transform corresponding to the forward transform applied by the forward filter bank module 401.

The inverse filter bank 413 provides processed audio signals 415 as an output. These processed audio signals 415 can be provided to storage 211 and/or transmitted to a remote device via a transceiver 213.

In this example, the block indication value 407 is both notified to the user and used in controlling the audio processing by the audio processing module 409. In other examples the block indication value 407 might be used for only one of these purposes.

FIG. 5 shows an example method that can be performed by the blocking determiner module 405.

The the blocking determiner module 405 is configured to receive the time-frequency domain audio signals 403 which can be as shown in FIG. 4 and described above. The time-frequency domain audio signals 403 are provided as an input to a microphone band-pass level estimator 501.

The microphone band-pass level estimator 501 is configured to determine, for a first frequency range, the energies of the microphone signals 215. The energies can be calculated for each channel i by

$${E}^{′} ( n , i ) = {{\sum }_{{b}_{1}}}^{{b}_{2}} {\vert S ( b , n , i ) \vert}^{2}$$

where b₁ and b₂ are bin indices determining the first frequency range that is to be used for the energy analysis. If the handheld electronic device 201 is a mobile telephone or other similar device a suitable first frequency range could be 700 Hz to 7 kHz. At this frequency range the effect of blocking a microphone 207 with a finger or other object is particularly prominent. Furthermore, at this frequency range, acoustic shadowing is not as prominent as it would be in the higher frequency ranges. This first frequency range therefore enables the assumption that any external sounds, regardless of their direction of origin, cause sufficiently similar sound energy levels at all microphones 207. Other frequency ranges could be used for the first frequency range in other examples.

The energies E′(n, i) are the microphone band energies 503 that are provided as an output from the microphone band-pass level estimator 501.

The microphone band energies 503 are provided to a combiner module 509 and also to a microphone band-pass correlation estimator module 505. The microphone band-pass correlation estimator module 505 can be configured to detect incoherent noise such as wind noise or handling noise within the microphone signals 215.

The microphone band-pass correlation estimator module 505 receives the time-frequency domain audio signals 403 and the microphone band energies 503 as inputs. The microphone band-pass correlation estimator module 505 is configured to determine which of the energies E′(n, i) is the largest. This provides a first channel index i₁(n). The microphone band-pass correlation estimator module 505 then determines which of the energies E′(n, i) is the second largest. This provides a second channel index i₂(n). Then, the microphone band-pass correlation estimator module 505 formulates the real-valued inter-channel cross correlation (ICC) by

$$ICC ( n ) = Real \{ \frac{{\sum }_{{b}_{3}}^{{b}_{4}} S ( b , n , {i}_{1} ( n ) ) {S}^{*} ( b , n , {i}_{2} ( n ) )}{\sqrt{{\sum }_{{b}_{3}}^{{b}_{4}} {\vert S ( b , n , {i}_{1} ( n ) ) \vert}^{2} {\sum }_{{b}_{3}}^{{b}_{4}} {\vert S ( b , n , {i}_{2} ( n ) ) \vert}^{2}}} \}$$

where b₃ and b₄ are bin indices determining the second frequency range that is used for the inter-channel cross correlation analysis. If the handheld electronic device 201 is a mobile telephone or other similar device a suitable second frequency range could be 50 Hz to 500 Hz. For this frequency range all external sounds such as sounds from sound sources or ambient sound would be highly correlated between the microphones 201 in a handheld electronic device 201, whereas wind noise or handling noise would be mostly uncorrelated between the microphones 207.

Based on the estimation of the inter-channel cross-correlation, the microphone band-pass correlation estimator module 505 generates indicator modifier values 507. These provide an indication of whether or not wind noise, or other incoherent noise is present in the microphone signals 215. The indicator modifier values can be generated by

$$α ( n ) = {lim}_{0 .. 1} [ \frac{ICC ( n )}{{ICC}_{lim}} ]$$

$$where {lim}_{0 .. 1} [ ]$$

operator denotes truncating the value within the brackets between 0 and 1, and ICCₗᵢₘ may for example be a threshold value such as 0.7. As a result, when ICC(n) is equal to ICCₗᵢₘ or higher, then α(n)=1, and when ICC(n) becomes smaller than ICCₗᵢₘ, then α(n) approaches zero.

In some examples the microphone band-pass correlation estimator module 505 can also be configured to take into account whether or not the levels of the microphone signals 215 are close to the microphone self-noise level. In such examples the indication modifier 507 can be configured so that if the second highest energy E′(n, i₂(n)) becomes close to the microphone self-noise level then the indicator modifier 507 can be overwritten to 1 or steered towards a value of 1. The energy level can be considered to be close to the microphone self-noise level if the energy level is within a threshold of the microphone self-noise level. The threshold could be 12 dB or any other suitable range.

Adjusting the indicator modifier 507 towards a value of 1 can indicate that the microphone 207 corresponding to the second highest energy microphone channel is blocked because the microphone signal 215 mainly comprises microphone self-noise. This could also indicate that other microphones 207 corresponding to the microphone channels having even lower energy are also blocked. This prevents the formula given above being used to provide small values for the indicator modifier 507 which could falsely indicate that wind noise, or other incoherent noise, was present.

The indicator modifier 507 α(n) are provided to the combiner module 509. The combiner module 509 also receives the microphone band energies 503 E(n, i).

The combiner module determines normalized microphone band energies based on the microphone band energies. First the channel iₘₐₓ(n) is determined where E′(n, i) is largest, and normalized energies are determined by

$$E ( n , i ) = \frac{{E}^{′} ( n , i )}{{E}^{′} ( n , {i}_{max} ( n ) )}$$

The combiner module 509 is configured to determine an instantaneous block indication value β(n, i) for each microphone channel i using

$$β ( n , i ) = {lim}_{0 .. 1} [ 2 ( \frac{- 10 {log}_{10} ( E ( n , i ) )}{{T}_{dB}} - 0.5 ) ] α ( n )$$

where T_{dB} is a threshold value related to how large attenuation should be to be considered as caused by a blocked microphone 207. In some examples T_{dB}=12 dB. Other values could be used in other examples of the disclosure.

As an example, if α(n)=1, when E(n, i) in decibels (for example, 10 log₁₀ E(n, i)) is 0 (that is, the channel has the same energy as the maximum energy channel), or when E(n, i) is in decibels higher than −6 dB, then β(n, i)=0. This means that the block indication value indicates that there is no blocking of the microphones 207.

If E(n, i) is in decibels −12 dB or below, then β(n, i)=1. This means that the block indication value indicates that there is blocking of the microphones 207.

Interpolation occurs between −6 dB (−T_{dB}/2) and −12 dB (−T_{dB}). The formula shows that, when the indication modifier α(n) is smaller than 1, that is when there is wind noise or similar noise present, then the instantaneous blocking values β(n, i) are scaled towards zero.

In some examples the combiner module 509 comprises an internal memory buffer configured to store previous block indication values 407. The memory buffer can store β(n, i) for n, . . . , n−(N−1), where N is the number of previous (including current) block indication values. In such cases, the actual indication value can be determined by

$$IND ( n , i ) = max [ 0 , \frac{( {\sum }_{m = n - ( N - 1 )}^{n} β ( m , i ) ) - {T}_{n}}{N - {T}_{n}} ]$$

where Tₙ is a temporal threshold value.

A practical configuration, for typical frame sizes such as 1024 samples, is Tₙ=5 and N=20. Interpreting the formula above, when β(n, i) values are all 1, then IND(n, i)=1. However, when some of the values β(n, i) become less than 1, then IND(n, i) becomes smaller and becomes zero when (Σ_{m=n-(N-1)}ⁿβ(m, i))=Tₙ.

In this example, the non-zero indication is provided only when there is no, or very little, wind noise present and when the block indication values 407 occur frequently enough during a given time interval so as to provide a robust estimate for whether or not a microphone 207 is blocked. This helps to avoid false positives indicating that a microphone 207 is blocked when it is not while still enabling accurate indications that a microphone 207 is blocked.

In some embodiments, the IND(n, i) values can be post processed so that when IND(n−1, i)=0, then unless IND(n, i) exceeds a threshold IND(n, i) is set to zero. The threshold could be 0.25 or any other suitable value. This avoids indicating very brief or minor blockings of the microphones 207.

In some embodiments, when IND(n, i) reaches value 1, then it can be kept at that value, until a defined time interval occurs in which no IND(n, i) values of 1 are observed. This procedure can be used when one or more microphones 207 are blocked, but the external sounds are not constantly available. For example, speech may have small pauses in the utterances. These pauses would cause the indications to drop as there might be no external sounds available to determine if the microphones 207 are blocked or not for that brief time period. Therefore, for a better user experience, the indication values are kept at 1 for a brief minimum interval. The minimum interval could be 0.8 seconds or any other suitable time period.

The combiner module 509 therefore provides block indication values 407 as an output. The block indication values 407 can be provided to a user interface 209 and or used for audio processing or used for any other suitable purpose.

FIGS. 6A to 6E show different configurations of the microphones 207 within example handheld electronic devices 201. These configurations comprise two microphones 207 arranged in different positions relative to each other. These different positions result in different distances and different amounts of acoustic shadowing between the microphones 207. This would result in different frequency bands being selected for the processing based on the different configurations of the microphones 207.

In FIG. 6A a first microphone 207 is provided at a first end of the handheld electronic device 201 and a second microphone 207 is provided at a second, opposite end of the handheld electronic device 201. The microphones 207 are also provided on different sides of the handheld electronic device 201 so that the first microphone 207 is provided on a front face and the second microphone 207 is provided on a rear face. This arrangement of the microphones 207 provides a large distance between the microphones 207 and also could result in a large amount of acoustic shadowing. This could reduce the upper limit that can be used for the respective frequency bands.

In FIG. 6B a first microphone 207 is provided at a first end of the handheld electronic device 201 and a second microphone 207 is provided at a second, opposite end of the handheld electronic device 201. In this example the microphones 207 are provided on the same side of the handheld electronic device 201 so that the first microphone 207 is provided on a front face and the second microphone 207 is also provided on the front face. This provides a large distance between the microphones 207 but could result in a medium amount of acoustic shadowing. This would result in less acoustic shadowing than the example configuration of FIG. 6A. This could therefore enable the upper limit of the frequency bands to be higher compared to the frequency bands used for the configuration of FIG. 6A.

In FIG. 6C both the first microphone 207 and the second microphone are provided at a first end of the handheld electronic device 201. However, the microphones 207 are provided on different sides of the handheld electronic device 201 so that the first microphone 207 is provided on a front face and the second microphone 207 is provided on a rear face. This provides a short distance between the microphones 207 but could result in a medium amount of acoustic shadowing. This would result in less acoustic shadowing than the example configuration of FIG. 6A. This could therefore enable the upper limit of the frequency bands to be higher compared to the frequency bands used for the configuration of FIG. 6A.

FIG. 6D shows another example in which both the first microphone 207 and the second microphone 207 are provided at a first end of the handheld electronic device 201. In this example the microphones 207 are provided on the same side of the handheld electronic device 201 so that the first microphone 207 is provided on a front face and the second microphone 207 is also provided on the front face. This provides a short distance between the microphones 207 and also results in a small amount of acoustic shadowing. This could therefore enable the upper limit of the frequency bands to be higher compared to the frequency bands used for the configuration of FIG. 6A and also for the configurations shown in FIGS. 6B and 6C.

In the example of FIG. 6E both of the microphones 207 are provided on the front face of the handheld electronic device 201 and are provided close to each other. However, in this example one microphone 207 is provided closer to the center of the handheld electronic device 201 than the other microphone 207. This can result in a medium amount of acoustic shadowing. This could result in more acoustic shadowing than the example shown in FIG. 6D and so the upper limits of the frequency bands would be lower compared to those used in the example of FIG. 6D.

In each of the example configurations shown in FIGS. 6A to 6E the handheld electronic device 201 comprises two microphones 207. Other numbers of microphones 207 could be used in other examples of the disclosure. Where there are more than two microphones 207 a plurality of different pairs of microphones 207 are available.

FIG. 7 shows example block indication values that could be obtained in an example where there is no wind noise.

In this example three different microphone channels are used. This could correspond to three microphones 207 provided within a handheld device 201 such as a mobile telephone.

The top row of plots show the energy levels for each of the different microphone channels. The middle row of plots show the block indication values for the different microphone channels. In the middle row the block indication values were calculated without taking into account the effect of wind noise, or other incoherent noise. The bottom row of plots also show the block indication values for the different microphone channels. In the bottom row the block indication values were calculated with the wind noise taken into account. These block indication values could be obtained using the process shown in FIG. 5 and described above, or using any other suitable process.

In this example there is no significant amount of wind noise. In this example a speech excerpt was played back in a loop from a loudspeaker, and the microphones 207 were occasionally blocked with a finger. As there is no significant amount of wind noise the wind-related processing does not significantly affect the output block indication values s in this case. The blocked microphones are well detected.

In this example the third microphone 207 was the camera microphone. In this case it was not possible to well block it with a finger and so appropriately the block indication values do not show this microphone 207 as being blocked.

FIG. 8 shows example block indication values that could be obtained in an example where there is wind noise.

This example also uses three different microphone channels. The top row of plots show the energy levels for each of the different microphone channels. The middle row of plots show the block indication values for the different microphone channels. In the middle row the block indication values were calculated without taking into account the effect of wind noise, or other coherent noise. The bottom row of plots also show the block indication values for the different microphone channels. In the bottom row the block indication values were calculated with the wind noise taken into account. These block indication values could be obtained using the process shown in FIG. 5 and described above, or using any other suitable process.

In this case there was a significant amount of wind noise present. The plots in the middle row, where wind is not accounted for in the processing, show a significant amount of false positive indications of a blocked microphone 207. In contrast, the plots in the bottom row show block indication values that are obtained using examples of the disclosure. In this example the false positive indications of a blocked microphone 207 have been avoided.

Examples of the disclosure therefore provide a robust method for detecting incoherent noise. This can then be used to avoid false positive indications of a blocked microphone 207 which could lead to poor user experience. For instance, this avoids a user being told that a microphone 207 is blocked when it is not blocked. In some examples this can avoid the audio processing being adjusted because a microphone 207 has been incorrectly identified as blocked.

FIG. 9 shows another example method that could be implemented using apparatus 101 and electronic device 201 as described above. The method enables estimates of the incoherent noise within the microphone signals to be obtained. This can then be used to provide spatial audio outputs.

At block 901 the method comprises obtaining microphone signals from at least two microphones 207. The microphones 207 can be provided within a handheld electronic device 201 as shown in FIG. 2 or within any other suitable type of device.

The microphone signals 215 can be obtained in any suitable format such as PCM.

At block 903 the method comprises processing the microphone signals in at least one frequency band to determine correlation between the at least two microphones 207.

Any suitable method, such as the methods described above, can be used to determine correlation between the at least two microphones 207.

In some examples, other characteristics of the microphone signals can also be determined.

The other characteristics could comprise direction information or any other information that could be used to provide a spatial audio output. The other characteristics could comprise spatial metadata for a spatial audio output.

In some examples directional information can be detected from the microphone signals by using the following equations. Other equations and processes could be used in other examples of the disclosure. First, assume a method has been applied to estimate the delays between all channel pairs. d₁ is denoted as the delay estimate between pair 1,2; d₂ as the delay estimate between pair 1,4; and d₃ as the delay estimate between pair 1,3. The delays are those that give maximum correlation for the two microphone signals.

In some examples the directional information can be determined from the delays by using the following vector algebra. A unit vector v is assumed. The unit vector v is to be formulated such that it would point to the direction-of-arrival. The unit vector axes 1 and 2 can be determined from the robustly estimated delays d₁ and d₂ by

$$v = [ \begin{matrix}{v}_{1} \\ {v}_{2} \\ {v}_{3}\end{matrix} ] = [ \begin{matrix}{d}_{1} / {d}_{1 max} \\ {d}_{2} / {d}_{2 max} \\ {d}_{3} / {d}_{3 max}\end{matrix} ]$$

where the max-values indicate the maximum possible delay at that axis, that is, when the sound arrives at the direction of that axis.

At block 905 the method comprises detecting if at least one of the microphone signal levels is close to a microphone self-noise level. The microphone self-noise comprises noise that is produced by a microphone 207 even when there is no sound source.

The method comprises, at block 907, estimating how predominant incoherent noise is within the microphone signals based on the correlation between the at least two microphones and whether or not at least one of the microphone signal levels is to the microphone self-noise level.

If the level of a microphone signal is close to the microphone self-noise level then this could be an indication that the microphone is blocked and none, or very little of the sound environment or the wind noise has been captured by the microphone 207. Therefore, if one of the microphones is close to the microphone self-noise level it could be assumed that this is due to a blockage and a lack of correlation would not be assumed to be an indication that incoherent noise is predominant in the microphone signals.

At block 909 a spatial audio output is provided. The spatial audio output is based on the microphone signals and an estimation of how predominant incoherent noise is within the microphone signals.

The spatial audio output can be synthesised using the spatial metadata or other characteristics to provide a spatial audio output for a user. Any suitable process can be used to synthesise the spatial audio output. The use of the estimate as to how predominant incoherent noise is within the microphone signals can provide more accurate spatial audio.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one non-transitory memory storing instructions that, when executed with the at least one processor, cause the apparatus at least to:
obtain microphone signals from at least two microphones;
process the microphone signals in a first frequency band to estimate signal levels of the at least two microphones in the first frequency band to provide an estimate of whether or not a microphone is blocked;
process the microphone signals in a second frequency band to determine correlation between the at least two microphones to provide an estimation of how predominant incoherent noise is within the microphone signals; and
determine whether or not a microphone within the at least two microphones is blocked based on outputs of the processing in the first frequency band and the processing in the second frequency band;
wherein at least one of the frequency bands is selected based at least in part on the distance between the at least two microphones and wherein the first frequency band comprises higher frequencies than the second frequency band.

2. An apparatus as claimed in claim 1, wherein the incoherent noise comprises at least one of: wind noise or handling noise.

3. An apparatus as claimed in claim 1, wherein the instructions, when executed with the at least one processor, cause the apparatus to process the microphone signals in the second frequency band to detect if at least one of the microphone signal levels is close to a microphone self-noise level and adjust an estimation of how predominant incoherent noise is within the microphone signals based on how close the microphone signal level is to the microphone self-noise level.

4. An apparatus as claimed in claim 1, wherein the instructions, when executed with the at least one processor, cause the apparatus to use outputs of the processing in the first frequency band and outputs of the processing in the second frequency band to determine whether or not a microphone within the at least two microphones is blocked to determine that a signal level difference is present in the microphone signals and determine that the signal level difference is not attributable to incoherent noise.

5. An apparatus as claimed in claim 1, wherein the first frequency band does not overlap with the second frequency band.

6. An apparatus as claimed in claim 1, wherein the instructions, when executed with the at least one processor, select the first frequency band based on the distance between the at least two microphones and acoustic shadowing of the at least two microphones such that energy level differences corresponding to a detected sound signal are low regardless of the direction that the sound signal arrives from.

7. An apparatus as claimed in claim 1, wherein the instructions, when executed with the at least one processor, select the second frequency band based on the distance between the at least two microphones and acoustic shadowing of the at least two microphones such that a phase difference between microphone signals from a sound source is low.

8. An apparatus as claimed in claim 1, wherein the frequency bands are selected based at least in part, on acoustic shadowing of the at least two microphones.

9. An apparatus as claimed in claim 8, wherein an upper frequency limit of the frequency bands is determined with an amount of acoustic shadowing.

10. (canceled)

11. A method, comprising:
obtaining microphone signals from at least two microphones;
processing the microphone signals in a first frequency band to estimate signal levels of the at least two microphones in the first frequency band to provide an estimate of whether or not a microphone is blocked;
processing the microphone signals in a second frequency band to determine correlation between the at least two microphones to provide an estimation of how predominant incoherent noise is within the microphone signals; and
using outputs of the processing in the first frequency band and the processing in the second frequency band to determine whether or not a microphone within the at least two microphones is blocked;
wherein at least one of the frequency bands is selected based at least in part on the distance between the at least two microphones and wherein the first frequency band comprises higher frequencies than the second frequency band.

12. A method as claimed in claim 11, wherein the incoherent noise comprises at least one of: wind noise or handling noise.

13. A method as claimed in claim 11, wherein the processing of the microphone signals in the second frequency band also comprises detecting if at least one of the microphone signal levels is close to a microphone self-noise level and adjusting an estimation of how predominant incoherent noise is in the microphone signals based on how close the microphone signal level is to the microphone self-noise level.

14-20. (canceled)

21. A method comprising:
obtaining microphone signals from at least two microphones;
processing the microphone signals in at least one frequency band to determine correlation between the at least two microphones;
detecting if at least one of the microphone signal levels is close to a microphone self-noise level;
estimating incoherent noise within the microphone signals based on the correlation between the at least two microphones and whether or not at least one of the microphone signal levels is close to the microphone self-noise level; and
providing spatial audio output based on the microphone signals and an estimation of how predominant incoherent noise is within the microphone signals.

22. A method as claimed in claim 11, wherein using outputs of the processing in the first frequency band and using outputs of the processing in the second frequency band to determine whether or not a microphone within the at least two microphones is blocked comprises determining that a signal level difference is present in the microphone signals and determining that the signal level difference is not attributable to incoherent noise.

23. A method as claimed in claim 11, wherein the first frequency band does not overlap with the second frequency band.

24. A method as claimed in claim 11, wherein the first frequency band is selected based on the distance between the at least two microphones and acoustic shadowing of the at least two microphones such that energy level differences corresponding to a detected sound signal are low regardless of the direction that the sound signal arrives from.

25. A method as claimed in claim 11, wherein the second frequency band is selected based on the distance between the at least two microphones and acoustic shadowing of the at least two microphones such that a phase difference between microphone signals from a sound source is low.

26. A method as claimed in claim 11, wherein the frequency bands are selected based at least in part, on acoustic shadowing of the at least two microphones.

27. A method as claimed in claim 11, wherein an upper frequency limit of the frequency bands is determined with an amount of acoustic shadowing.

28. A non-transitory program storage device readable with an apparatus, tangibly embodying a program of instructions executable with the apparatus for performing the method of claim 11.
